(19) United States
(12) Patent Application Publication
(10) Pub. No.: US 2026/0211780 A1
(43) Pub. Date: Jul. 23, 2026

(54) LAYER ENSEMBLE AVERAGING FOR FAULT-TOLERANT MEMRISTIVE NEURAL NETWORKS

(71) Applicant: THE GEORGE WASHINGTON UNIVERSITY, Washington, DC (US)

(72) Inventors: Gina C. ADAM, Washington, DC (US); Osama YOUSUF, Washington, DC (US)

(21) Appl. No.: 19/453,522

(22) Filed: Jan. 20, 2026

Related U.S. Application Data
(60) Provisional application No. 63/746,643, filed on Jan. 17, 2025.

(51) Int. Cl. G06F 11/14

(52) U.S. Cl. CPC G06F 11/1476

(57) ABSTRACT

The present disclosure provides a system and method for a neural network or similar on defective arrays of energy-efficient memory devices. The system includes mapping a weight matrix of the neural network to multiple copies on the memory array with some defective devices, wherein each copy corresponds to a layer of the neural network. The system further includes averaging outputs from multiple copies of each layer's mapping on the crossbar array to produce an output for each layer. Redundancy parameters, such as (α,β) control how many copies of each layer's rows are used for averaging. The system also includes converting network weights to conductance matrices that are mapped differentially to pairs of memory devices. An algorithm is used for finding ensemble mappings on defective arrays that avoids faulty devices.

### RELATED APPLICATIONS

This application claims the benefit of priority of U.S. Provisional Application No. 63/746,643, filed on Jan. 17, 2025, including the references cited therein, the entire content of which is relied upon and incorporated herein by reference in its entirety.

### GOVERNMENT LICENSE RIGHTS

This invention was made with Government support under Grant/Contract No. 70NANB22H018 awarded by the National Institute of Standards and Technology, Grant/Contract No. 2239951 by the National Science Foundation, and Grant/Contract No. FA9550-23-1-0173 by the Air Force Office of Scientific Research. The Government has certain rights in this invention.

### FIELD

The present disclosure relates to fault-tolerant analog neural network implementations, and more particularly to a layer ensemble averaging technique for improving the performance of artificial neural networks implemented on an unreliable hardware fabric with some defective devices.

### BACKGROUND

Artificial neural networks have become increasingly important in various fields, including image recognition, natural language processing, and decision-making systems. As these networks grow in complexity and scale, there is a growing need for more efficient and powerful hardware implementations to support their operation. Traditional computing architectures based on the von Neumann model face limitations in processing the massive parallel computations required by neural networks, leading to bottlenecks in performance and energy efficiency.

New types of non-volatile memory devices, e.g. resistive switching (memristive) devices, phase change memories, spintronic devices, etc., have emerged as promising technologies for implementing artificial neural networks in hardware. These devices can naturally store synaptic weights in a non-volatile fashion based on their intrinsic physical phenomena potentially offering significant advantages in terms of speed, energy efficiency, and scalability. By arranging such emerging devices in arrays, it is possible to perform vector-matrix multiplications (a core operation in neural networks) with high parallelism and efficiency.

However, the practical implementation of artificial neural networks in such hardware faces a critical challenge, namely the presence of device non-idealities and variability in device arrays. These can include stuck-at faults, where devices are permanently fixed in a high or low conductance state, as well as variations in device characteristics due to manufacturing imperfections or environmental factors. Such non-idealities can lead to errors in computation and degradation of network performance, potentially limiting the practical utility of such hardware neural networks.

Various approaches have been proposed to address these challenges. Each approach can be classified into two broad categories. The first category focuses on circuit-level and device-level optimizations, such as alterations to the crossbar configuration and circuitry or the device material stack, and the second on neural network-level algorithmic optimizations, such as advanced programming or weight-to-device mapping and encoding schemes. However, existing methods have limitations and trade-offs in terms of their effectiveness, scalability, or compatibility with different types of devices and neural network architectures. See Y. Fang, et al., Improvement of HfOx-Based RRAM Device Variation by Inserting ALD TiN Buffer Layer, IEEE Electron Device Letters, Vol. 39, No. 6, June 2018; C. Li, Analogue signal and image processing with large memristor crossbars, Nature Electronics, 2017; D. Joksas et al, Committee machines—a universal method to deal with non-idealities in memristor-based neural networks, Nature Communications, 11:4273, 2020.

As the field of neuromorphic computing continues to advance, there is an ongoing need for robust and versatile techniques to mitigate the impact of device non-idealities in neural networks implemented on hardware. Such techniques should ideally be applicable to a wide range of device technologies, network architectures, and application domains, while maintaining the potential performance and efficiency benefits of the hardware fabric utilized.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a system and method for implementing a neural network on arrays of memory devices with some device defects is provided. The method includes mapping multiple copies of a weight matrix on the array for each layer of the neural network. In one embodiment, each of the copies can be a subset array of a plurality of memory devices that are a subset of the neural network memory device array.

According to other aspects of the present disclosure, the system may include one or more of the following features. The system can use a parameter α that indicates the total number of redundant mappings of each conductance matrix and parameter β that controls how many copies of each layer's rows (out of a) are used for averaging. The system may include converting network weights to conductance matrices that are mapped differentially to pairs of non-volatile memory devices. The system may include ways of mapping the arrays of memory devices and identifying the working devices and the faulty ones. The system may include using an algorithm for finding ensemble mappings on a defective array that avoids faulty devices. The system may include averaging currents from multiple non-defective row copies to produce each layer's output. Thus, the system accounts for various defects, including faulty devices and other device non-idealities.

According to another aspect of the present disclosure, a system for implementing a neural network on non-volatile memory arrays is provided. The system includes arrays of these devices and a controller configured to map multiple copies of a weight matrix on the array, where each copy corresponds to a layer of the neural network. The controller is further configured to average outputs from multiple non-defective copies of each layer's mapping on the array.

According to other aspects of the present disclosure, the system may include one or more of the following features. The controller may be configured to use a set of redundancy parameters (α,β) that controls the total number of redundant mappings and how many non-defective copies of each layer's rows are used for averaging. The controller may be configured to convert network weights to conductance matrices that are mapped differentially to pairs of devices. The controller may be configured to measure (parts of) the arrays of memory devices and identify the faulty ones. The controller may be configured to use an algorithm for finding ensemble mappings on a defective array that avoids faulty devices. The controller may be configured to average currents from multiple non-defective row copies to produce each layer's output.

According to another aspect of the present disclosure, a non-transitory computer-readable medium storing instructions or a custom hardware capable of performing desired computations is provided. A processor executing the instructions or the custom hardware performs operations including mapping a weight matrix to multiple copies on an array, where each copy corresponds to a layer of a neural network. The operations also include averaging outputs from multiple non-defective copies of each layer's mapping on the crossbar array.

According to other aspects of the present disclosure, the operations may include one or more of the following features. The operations may include using redundancy parameters (α,β) that control how many non-defective copies of each layer's rows are used for averaging. The operations may include converting network weights to conductance matrices that are mapped differentially to pairs of devices. The operations may include state reading and writing procedures for the devices in the arrays. The operations may include using an algorithm for finding ensemble mappings on a defective array that avoids faulty devices. The operations may include averaging currents from multiple non-defective row copies to produce each layer's output.

The foregoing general description of the illustrative embodiments and the following detailed description thereof are merely exemplary aspects of the teachings of this disclosure and are not restrictive.

### BRIEF DESCRIPTION OF THE FIGURES

The accompanying drawings are incorporated in and constitute a part of this specification. It is to be understood that the drawings illustrate only some examples of the disclosure and other examples or combinations of various examples that are not specifically illustrated in the figures may still fall within the scope of this disclosure.

FIGS. 1(a)-1(b) is a schematic and flowchart of proposed Layer Ensemble Averaging

FIG. 2 shows a hardware setup for Layer Ensemble Averaging with a memristor (ReRAM) array, in accordance with an example embodiment of the disclosure.

FIGS. 3(a)-3(f) show a memristor (ReRAM) device and array characterization.

FIGS. 4(a), 4(b) show performance results of Layer Ensemble Averaging vs. existing hardware fault tolerance schemes on a MNIST handwritten digit classification task.

FIGS. 5(a), 5(b), 5(c) show hardware of layer ensemble averaging for a Yin-Yang classification problem.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

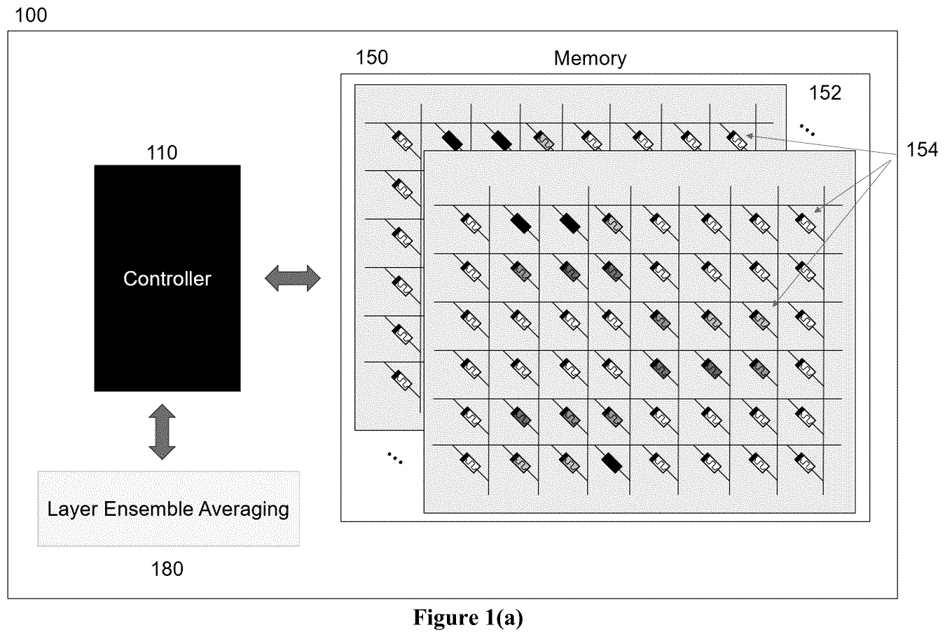

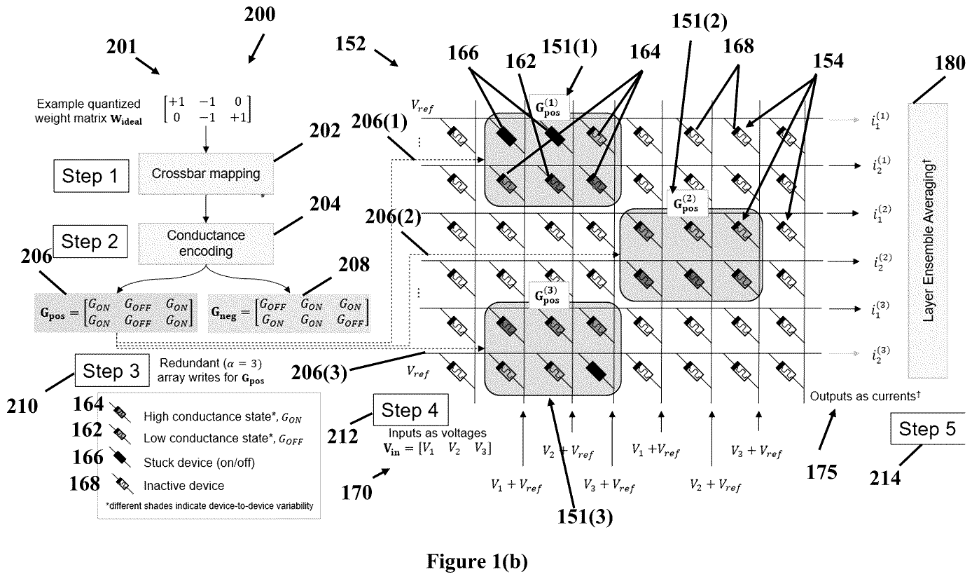

Turning to the drawings, FIG. 1 show a physical computing approach based on matrix operations on a memory device array having a plurality of memory devices. The physical computing approach can be, for example, a machine learning system, for example a fault-tolerant neural network system 100 in accordance with a non-limiting illustrative embodiment of the disclosure. The system 100 includes a controller 110, a storage or memory 150, and a Layer Ensemble Averaging (LEA) component 180. The memory 150 can be any suitable device, and here is shown as a memory device array 152 of a plurality of non-volatile memory devices such as memristor devices 154, in accordance with one non-limiting example embodiment of the present disclosure. In the shown, the memory 150 is an array 152 of 20,000 memristor devices 154, but other embodiments may include arrays of varying dimensions and different memory technologies. In addition, as shown, more than one array 152 can be provided.

In addition, one or more of the memory devices 154 can have one or more defects, for example one or more non-idealities. The Layer Ensemble Averaging operation improves fault tolerance and performance of artificial neural networks implemented on hardware having defects, including faulty hardware (faulty devices), and other device non-idealities, for example including the memristor devices 154. As used herein, the terms defective, faulty, and non-ideal are used interchangeably, wherein faulty, non-ideal and idealities refer to devices having any defect. The controller 110 is configured to map multiple copies of a weight matrix on the array 152, where each copy corresponds to a layer of the neural network. The controller 110 is further configured to average outputs from multiple non-defective copies of each layer's mapping on the array 152.

Referring to FIG. 1(b), the controller 110 maps an example weight matrix W_{ideal} 201 to a crossbar (i.e., the array 152) of non-ideal memristive devices 154 (i.e., defective devices) using the Layer Ensemble Averaging operation 200. A weight matrix is a numerical table of parameters that defines how strongly signals are multiplied and combined between layers of a neural network. The values in the weight matrix are generated during a training process, in which the network is repeatedly adjusted to reduce error on example data. Once trained, the weight matrix represents the learned model and is stored in memory for use during inference. The weight matrix represents ideal neural network weights rather than physical device states. The discrete values +1+1, −1−1, and 0 correspond to simplified signed weights used for illustration of quantized inference.

To determine where the ideal weight matrix 201 should be mapped, the controller 110 evaluates candidate regions of the device array at step 202 and identifies those that most closely approximate a desired target behavior. Because physical memristor devices 154 are non-ideal, different regions of the array may exhibit different amounts of variation relative to an ideal target conductance profile. The output of this step are physical addresses of sub-arrays within the broader array of memristor devices.

To determine where the ideal weight matrix 201 should be mapped, the controller 110 evaluates candidate regions of the device array at step 202 and identifies those regions that are most suitable for implementing the desired target behavior. In the illustrated embodiment, the candidate regions include subarrays G⁽¹⁾ₚₒₛ 151(1), G⁽²⁾ₚₒₛ 151(2), and G⁽³⁾ₚₒₛ 151(3). These regions may also be referred to herein as subarrays, blocks, or contiguous regions of the larger array 152. The figure is illustrative, and other embodiments may evaluate a different number of candidate regions, with different sizes or shapes.

Because physical memristive devices 154 are non-ideal, different regions of the array may exhibit various levels of variability, noise, or defects. As a result, some regions are better suited than others for accurately representing neural network weights. The controller 110 evaluates these candidate regions using stored or measured device information in order to identify regions whose collective behavior most closely matches a desired target conductance profile.

The output of step 202 is a set of physical addresses corresponding to selected subarrays within the broader array of memristive devices. These addresses specify where the encoded weight matrix will be written on the chip.

In an ideal software implementation, each entry of the weight matrix is represented with high numerical precision. However, when the weight matrix is mapped to a physical array of non-ideal devices, device faults and variability can alter the effective values of individual weights. For example, a device intended to represent a particular weight value may exhibit a conductance that is higher or lower than its target due to manufacturing variation, limited programmability, drift over time, or permanent defects such as being stuck in a high- or low-conductance state. As a result, the effective hardware-implemented weight may differ from the corresponding ideal weight value.

The impact of such faults depends on their severity and distribution. Minor deviations may slightly perturb the weight matrix and introduce small inference errors, while more severe faults, such as completely non-functional devices or highly noisy rows, may significantly distort the contribution of certain weights or outputs. Without mitigation, these distortions can accumulate across layers and degrade overall network performance.

The Layer Ensemble Averaging operation 200 addresses this problem by identifying and accounting for the degree of fault or variation associated with different regions of the array, redundantly mapping the weight matrix to multiple physical locations, and selectively combining or suppressing their contributions during inference. In this manner, the effective weight matrix used by the hardware more closely approximates the ideal trained matrix, even in the presence of defective devices.

In some embodiments, the mapping process evaluates candidate locations using a variation metric that quantifies the aggregate deviation between the target conductance values and the actual or estimated conductance values of devices in a candidate region. This metric may be computed using information obtained from device characterization, prior measurements, or write-and-read operations on the array. Regions exhibiting lower aggregate deviation are preferred, as they are expected to more accurately represent the ideal weight matrix during inference.

Although one specific form of variation metric may be used in certain implementations, other metrics may be employed in alternative realizations, including metrics based on absolute error, squared error, statistical distance, or other measures of device mismatch or reliability. For comparing different candidate mappings, the variation metric may be aggregated across multiple rows or columns corresponding to the dimensions of the weight matrix. This provides a computationally efficient way to estimate the relative quality of different mappings and to select those that best mitigate the impact of device non-idealities.

In some embodiments, multiple candidate mappings are selected to form an ensemble of mapped representations for a given weight matrix. For each output dimension (for example, each row of the weight matrix), a subset of the ensemble members may be selected for use during inference based on their respective variation metrics. This selection process may be performed once, prior to inference, and may exclude devices or rows that exhibit excessive deviation or defects.

Accordingly, an ideal weight matrix may be mapped redundantly to multiple physical representations, with a configurable number of those representations actively contributing during inference. The number of active representations may be treated as a tunable parameter α, allowing the system to trade off robustness, accuracy, and resource usage.

The mapping process may be implemented using different strategies. In one mode, candidate locations on the array are selected randomly (e.g., using uniform random sampling) subject to non-conflict constraints. In another mode, a greedy or more exhaustive search is performed to identify mappings that minimize the selected variation metric. Randomized approaches may offer lower runtime and are suitable when device variations or defects are approximately uniform, while greedy approaches may be preferable when defect distributions are structured or when higher computational cost is acceptable.

Other mapping approaches may also be used in alternative embodiments, including optimization or matching-based techniques, although such methods may involve higher computational complexity.

In the described formulation, the mapping process of network layers onto the memristive arrays relies on relative quality comparisons between candidate regions of the device array rather than on absolute thresholds tied to a specific metric or device technology. As a result, the approach is scalable to different network sizes, layer dimensions, and memory technologies, and may be adapted to arrays with different dynamic ranges, noise characteristics, or device behaviors.

The mapping process is not limited to a single deterministic procedure, nor does it require a particular mathematical metric or fixed sequence of operations. Instead, its distinguishing feature is the use of comparative evaluation across multiple candidate regions, combined with ensemble redundancy and defect-aware selection. This makes the approach flexible and broadly applicable across different hardware technologies while still enabling improved robustness against device non-idealities.

Accordingly, the novelty lies not in any single metric or selection rule, but in the overall strategy of (i) evaluating multiple candidate regions, (ii) selecting a subset based on relative quality, and (iii) using redundant mappings for each network layer and selective participation during inference.

Though other mapping can be provided, for example to better illustrate the present invention, consider the ideal weight matrix W_{ideal} 201 intended to be mapped to a memristive array 152 containing many possible subarrays. Prior to mapping, the array may be characterized to determine approximate conductance behavior, variability, or defect information for different regions.

Assume the controller 110 evaluates several candidate subarrays, including regions 151(1), 151(2), 151(3), and others not shown. For each candidate region, the controller estimates how closely the devices in that region can collectively represent the desired conductance values associated with the ideal weight matrix. For instance: Region 151(1) may contain devices whose conductances closely track their programmed targets, with relatively low variation across rows. Region 151(2) may exhibit moderate variation, but without severe defects. Region 151(3) may include some higher-variation devices, but still perform better overall than alternative regions that include stuck-at faults or unusable rows. Other candidate regions may be rejected because they contain clusters of defective devices, excessive noise, or rows that consistently deviate from target behavior.

Based on this relative comparison, the controller selects regions 151(1), 151(2), and 151(3) as suitable subarrays for mapping redundant copies of the weight matrix. Importantly, this selection does not require the regions to meet any absolute quality threshold; rather, they are chosen because they are better than other available options for that particular chip and configuration.

Once selected, the physical addresses of these regions are recorded, along with associated metadata such as row-wise quality indicators. This information is later used during inference to determine which rows or subarrays actively contribute to the output and which may be suppressed or down-weighted by the controller 110 during inference.

Thus, overall, the controller 110 starts with a weight matrix W_{ideal} 201, which comes from a training process and can be provided by a user and stored in or at the controller 110, such as in a separate storage device or memory. At step 202, the controller 110 determines “mapping” locations on the array 152, where W_{ideal} could be mapped. The input is W_{ideal} as well as how many locations to find (dictated by the α parameter). The output is physical addresses of sub-arrays within the memristor array. A physical address must contain information required to accurately determine portions of the sub-array that are being used for mapping, such as the row number, column number, as well as the overall block size. For the example region 151(1) in FIG. 1(b), one representation of the physical address could be row 1, column 2, and a block size spanning 2 rows and 3 columns. The controller 110 would store this mapping information for all redundant mappings for all neural network layers being mapped to the memristor array 152.

At step 204, once the mapping has been established, the controller 110 determines an appropriate encoding for the ideal weight matrix W_{ideal}. The inputs to this step include the weight matrix W_{ideal} and the mapping information from step 202, and the outputs include one or more conductance matrices, such as Gₚₒₛ 206 and G_{neg} 208, with the total number corresponding to the redundancy parameter α.

The purpose of step 204 is to translate the trained neural-network weights into physical values that the hardware can store and use. The weights indicate how strongly each input influences each output, but the memristor array operates using electrical properties rather than abstract numbers. Accordingly, the numerical weights are converted into conductance values, which determine how much current flows through each device when voltages are applied during inference.

The mapping information is used at step 204 to determine which physical devices receive which conductance values, such that the encoded weights are written to the locations selected in step 202. In this manner, step 202 determines where the weights are placed on the chip, and step 204 determines how those weights are represented electrically. The ultimate goal of layer ensemble averaging is to realize vector-matrix multiplication/neural network inference accurately.

In some embodiments, the ideal weight matrix W_{ideal} 201 is encoded using a differential representation scheme as Gₚₒₛ 206 and G_{neg} 208, in which each numerical weight is represented by a pair of physical devices. One device represents a positive contribution and the other represents a negative contribution, and the effective weight value is determined by a combination (for example, a difference) of their respective conductances. For example, if a particular weight has a relatively large positive value, the controller 110 may assign a high target conductance (e.g., a programmed “ON” state) in Gₚₒₛ and a low target conductance (e.g., an “OFF” state) in G_{neg}. Conversely, a negative weight may be encoded by reversing these assignments, and a near-zero weight may be encoded by assigning similar conductance values to both matrices. This approach enables the representation of signed weights using devices that may inherently support only non-negative physical values. In other embodiments, alternative representation schemes may be used for encoding, including single-device encodings, multi-level encodings, or other representations suitable for the underlying memory technology.

There may also be multiple variants of realizing a representation scheme for the encoding step 204. In one encoding variant, referred to herein as a baseline or simple encoding, the ideal weight matrix is converted into corresponding positive and negative conductance matrices 206, 208, and these conductance values are replicated across multiple redundant copies. In this variant, each redundant copy uses the same target conductance values for corresponding devices, providing a straightforward and computationally efficient encoding method.

In another encoding variant, referred to herein as an error-aware or refined encoding, the baseline encoding serves as an initial configuration. The device conductances are then selectively adjusted based on information about the target weight values and the observed or estimated behavior of individual devices. The objective of this refinement process is to reduce the discrepancy between the effective weights produced by the physical devices and the original ideal weight matrix. For example, the controller 110 may increase the target conductance assigned to the positive device, decrease the target conductance assigned to the negative device, or apply a combination of such adjustments, so that the combined effect of the two devices more closely matches the intended weight value when implemented on the non-ideal hardware.

The discrepancy between the ideal weights and the encoded weights may be quantified using an encoding or mapping error metric, which measures how closely the hardware-implemented weights approximate the ideal weights. While one specific form of such a metric may be used in certain implementations, other error measures may be employed in alternative realizations, including metrics based on absolute error, relative error, squared error, or task-level performance impact.

Under a differential encoding scheme, each logical weight in the neural network corresponds to multiple physical devices, such as a pair of devices associated with positive and negative contributions. As a result, the dimensionality of the hardware representation may be increased relative to the software representation. This tradeoff enables improved robustness and expressivity when mapping signed or quantized weights onto non-ideal physical devices.

In some embodiments, quantized weight values (for example, multi-level or ternary values) are encoded using discrete device states, with different combinations of device conductance states corresponding to different logical weight values. The specific mapping between logical weight values and physical device states may vary across layers, devices, or system implementations.

In the example configuration of the array 152 in FIG. 1(b), input signals 170 are applied along one dimension of the device array (such as columns), and output signals 175 are measured along the orthogonal dimension (such as rows). However, this arrangement is provided for illustrative purposes only, and other input/output orientations or signal routing schemes may be used in alternative embodiments, depending on system constraints and design choices.

At step 210, the controller can do the actual write operation by writing the encoded Gₚₒₛ matrix and the encoded G_{neg} matrix onto the memristor devices 154 on the array 152 (onto devices at the mapping addresses). In some embodiments, the controller 110 writes each encoded conductance matrix 206, 208 to one or more contiguous blocks (subarrays) of memory devices on the non-ideal chip in accordance with corresponding mappings determined for that matrix at step 202. Each subarray 151(1), 151(2), 151(3) represents a physical realization of a portion of the neural network weights and may correspond to one member of a layer ensemble. In FIG. 1(b), each encoded conductance matrix 206, 208 is written to contiguous blocks (subarrays G⁽¹⁾ₚₒₛ 151(1), G⁽²⁾ₚₒₛ 151(2), and G⁽³⁾ₚₒₛ 151(3)) of devices on the non-ideal chip according to their respective mappings. In one non-limiting example, values of G_{ON} could be obtained by tuning all devices in the available array 152 or relevant sub-arrays 151(1), (2), or (3), to their high conductance state and recording the average on state conductance. A similar step could be repeated for determining values of G_{OFF}. The controller can store this information and use it later for writing individual devices from the array 152.

For simplicity, only the layer ensemble mapping for Gₚₒₛ is shown, but if a differential encoding scheme is used, both Gₚₒₛ 206 and G_{neg} 208 must be mapped for each layer to fully implement the neural network. The number of subarrays (for example, three subarrays in the illustrated embodiment in FIG. 1(b)) corresponds to the number of redundant or ensemble representations a selected for that layer. The dimensions of each subarray (for example, a 3×2 block, which corresponds to the 3×2 W_{ideal} matrix, which is an example and other matrix dimensions can be utilized) are determined by the size of the portion of the weight matrix being mapped and by system-level design choices, such as available hardware resources, redundancy targets, or fault-tolerance requirements. These values are illustrative only, and other embodiments may use different numbers, sizes, or shapes of subarrays. In addition, G1, G2, G3 are selected based on the encoding step, which runs in the controller. For illustrative purposes, none of the devices in G⁽¹⁾, G⁽²⁾, and G⁽³⁾ are inactive (in the example) because the example is attempting to show how some W_{ideal} matrix would be mapped to a system with a very large array. In this representative example, we chose α=3, so each W_{ideal} would be encoded by 3 Gₚₒₛ matrices and 3 G_{neg} matrices. All 3 of these would be active, but certain rows can be chosen to be disabled during inference.

Each mapping includes additional information describing device quality, such as row-wise or region-wise variation, defects, or reliability indicators derived from prior device characterization or measurement. This information may be based on aggregate deviation metrics that summarize how closely devices in a given row or block are expected to match desired conductance values. The metrics need not be limited to a single mathematical form and may include absolute deviation, statistical variation, error likelihood, or other indicators of device suitability. This mapping information may be generated during a calibration or characterization phase, updated during device programming or readback operations, and/or stored in memory associated with controller 110 for later use.

During inference, one can simply average from the redundant Gₚₒₛ/G_{neg} mappings and that is how the overall operation happens.

During inference, at step 212, the controller 110 uses the previously generated mapping and encoding information to determine which portions of the device array 152 actively contribute to the computation. This is done, for example, by the LEA 180 averaging the redundant Gₚₒₛ/G_{neg} mappings. In particular, rows or devices identified as highly defective or unreliable are selectively suppressed so that their electrical contributions do not participate in the ensemble averaging process. The voltage inputs 170 represent numerical input values to the neural network, expressed in an electrical form. Each voltage corresponds to one component of an input data vector (for example, a pixel value, sensor reading, or feature value) that has been converted from a digital representation into an analog signal suitable for processing by the memory array. In one embodiment, the voltages can be obtained by scaling an input data vector by a previously determined read voltage for the memristor array.

For example, the system suppresses rows within relevant sub-arrays. In FIG. 1(b), for the output currents 175, certain arrows are grayed out. If you trace these grayed out arrows back via the row-wires to their sub-array mappings 151(1), 151(2), and 151(3), you can see how these arrows correspond to rows which had stuck (blacked out) devices. This illustrates that the controller discards (suppresses) currents only from portions (rows) of the mapping that have really problematic devices. The processor determines the suppression from the device characterization information, which is recorded and stored in the controller in the mapping step 202. The suppression can be done in any suitable manner, for example, using the controller without any additional hardware, the controller discards currents from suppressed lines during averaging in 180. Other ways are also possible, such as manipulating the input voltages such that rows to be suppressed always contribute zero current.

The voltages are generated by input circuitry, such as digital-to-analog converters, and are applied to one dimension of the array (for example, the columns of the crossbar). When the input voltages are applied, currents flow through the devices in accordance with their programmed conductances. The resulting output currents 175 represent weighted combinations of the input voltages, effectively implementing a matrix-vector multiplication corresponding to a neural network layer.

In the illustrated example, multiple output currents are shown to reflect different output neurons or different ensemble members. The number of input voltages and output currents shown in the figure is illustrative only. More generally, the number of inputs corresponds to the dimensionality of the input vector, and the number of outputs corresponds to the number of neurons or output features produced by the layer.

As illustrated, one or more of the memory devices 154 may be in a low conductive state 162 (light gray), and one or more of the memory devices 154 may be in a high conductive state 164 (dark gray), with varying shades indicating device-to-device variability. In addition, one or more of the memory devices 154 may be in a stuck/faulty state 166 (black) or an inactive state 168 (white).

The outputs 175 can be read as currents in step 214 as part of the layer ensemble averaging module 180. For layers implemented using an ensemble of redundant mappings, output currents from selected ensemble members are combined in step 214, for example by averaging or summation, to produce a final output. Rows or devices previously identified as defective may be excluded from this combination, thereby improving robustness and accuracy.

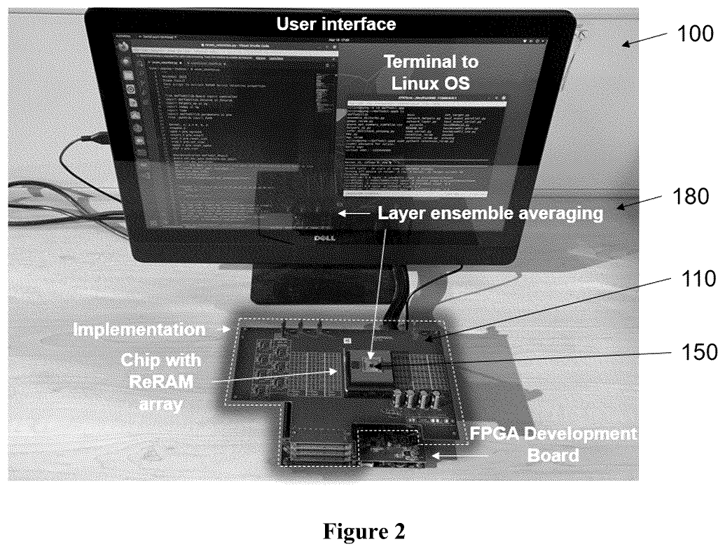

FIG. 2 shows an example of an implementation. The system 100 can include a Field-Programmable Gate Array (FPGA) development board that interfaces with a printed circuit board housing the memristor chip via a FPGA mezzanine card (FMC) connector. Other embodiments could include an ASIC, system-on-chip (SoC), or other custom integrated hardware implementations configured to perform the same or similar control, processing, and interface functions. The controller 110 connects with the development board and the memristive memory devices 150, and is configured to implement a Layer Ensemble Averaging operation 180 on the memory device array 152.

As noted, emerging types of memory device arrays may be used to implement neural network computations directly in hardware. Examples of such arrays include, but are not limited to: memristive or resistive RAM (ReRAM) crossbar arrays (see Hu et al., Memristor-Based Analog Computation and Neural Network Classification with a Dot Product Engine, Advanced Materials, 1705914, 10 pages, 2018), in which conductance values of programmable resistive devices encode neural network weights and enable analog matrix-vector multiplication, phase-change memory (PCM) arrays (see Burr et al., Experimental Demonstration and Tolerancing of a Large-Scale Neural Network (165 000 Synapses) Using Phase-Change Memory as the Synaptic Weight Element, IEEE Transactions on Electron Devices, Vol. 62, No. 11, pp. 3498-357 November 2015) which store weights using different material phases with distinct electrical characteristics, or ferroelectric or charge-based memory arrays, such as FeRAM or flash-derived analog memory (see Long, et al., A Ferroelectric FET-Based processing-in-memory architecture for DNN Acceleration, IEEE Journal, Vol. 5, No. 2, pp. 113-122, December 2019), adapted to support multi-level or analog weight storage. These and similar memory technologies have been widely described in technical literature as candidates for accelerating neural network inference by performing computations in or near memory. However, such arrays are inherently subject to device non-idealities, including variability across devices, temporal drift, limited precision, noise, and permanent defects arising from fabrication or wear.

These non-ideal behaviors can distort the effective weights realized in hardware and thereby degrade neural network accuracy if not properly addressed. The layer ensemble averaging operation 200 mitigates the impact of these effects by redundantly mapping network weights across multiple regions of the array and selectively combining or excluding their contributions during inference. By leveraging ensemble redundancy and defect-aware selection, the operation improves robustness and maintains inference accuracy despite underlying device imperfections.

In some cases, the layer ensemble averaging operation 200 involves mapping each layer of a neural network to multiple copies on an array proportional to layer-wise sensitivities. The outputs from multiple non-defective copies of each layer's mapping on the array may then be averaged to produce the final output for that layer. This averaging process compensates for device-to-device variations and defects.

The Layer Ensemble Averaging (LEA) module 180 averages, for each output, the currents from β active rows (here β=2), and the α−β are discarded (grayed out). The LEA 180 is programmed logic inside the controller. The controller sends commands whenever we have to write data into the array 152, or read data from it. The LEA 180 attempts to read the output current from the redundant mappings 151(1), 151(2), 151(3). However, we don't want to just average things without suppression. Otherwise, there would be no benefit of the redundant mappings in step 210. So, the controller, at the LEA 180, averages currents from each mapping and each un-suppressed row. In FIG. 1(b), the particular example shown is for: α=3, so Gₚₒₛ 206 is mapped to three sub-arrays redundantly (again, 151(1) through (3)). β=2, so for each row, 180 will only use 2 (out of the 3) available currents, essentially suppressing the ones which had more faulty devices. α and β are both user parameters that can be altered via the controller. Overall, currents would be averaged across the α redundant mappings for each row. Since we have a 3×2 matrix in FIG. 1(b), we would need 3 values in the input vector (170), and each of the 3 mappings would produce two outputs, leading to a total of 6 outputs. The averaging 180 averages i) current i₁ from 151(2) and i₁ from 151(3) (i₁ from 151(1) is suppressed) and b) current i₂ from 151(1) and 151(2) (because 151(3) is suppressed).

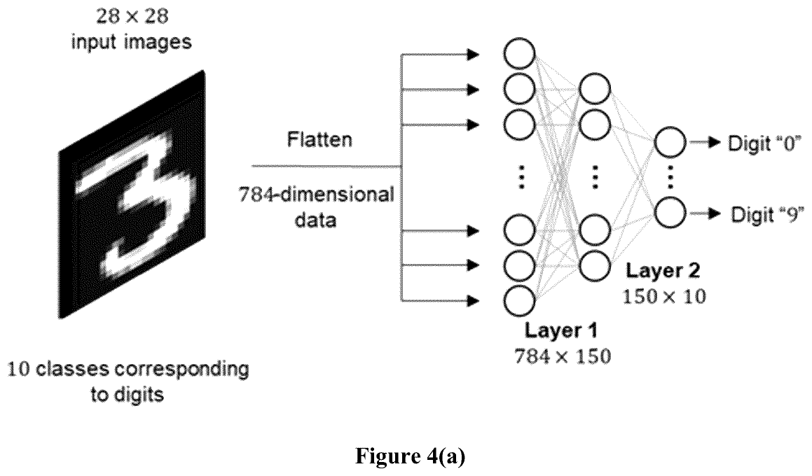

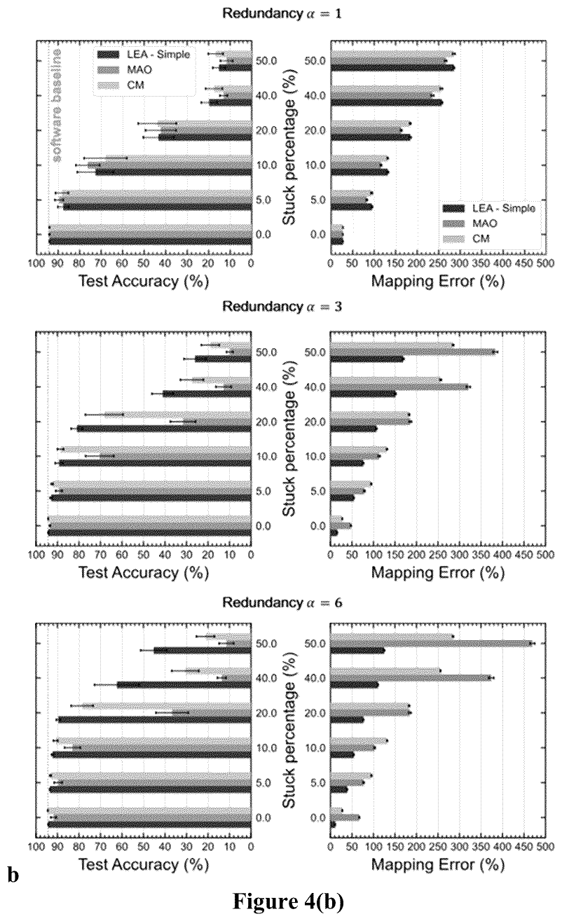

Layers are the ordered stages of computation inside a neural network. Each layer takes numerical inputs, applies a mathematical transformation, and passes the result to the next layer. A neural network can have an input layer (which receives the data), zero or more hidden layers (which perform intermediate processing), and an output layer (which produces the final result). A schematic of a neural network with 2 layers (an input and an output layer) is included in FIG. 4(a). Each layer maintains a set of numerical values inside of it, called layer parameters, which dictate the mathematical transformation that inputs end up going through when they pass through a layer. According to the present invention, neural networks that maintain numerous redundant copies of a layer, are referred to as an ensemble of layers, or a layer ensemble. When operating the neural network, layer ensembles are run together, with their outputs combined (for example, by averaging or voting) to produce a single final result. For memristor-based neural networks, using an ensemble improves accuracy compared to relying on a network with no redundant copies of layers (or, said differently, no layer ensemble averaging).

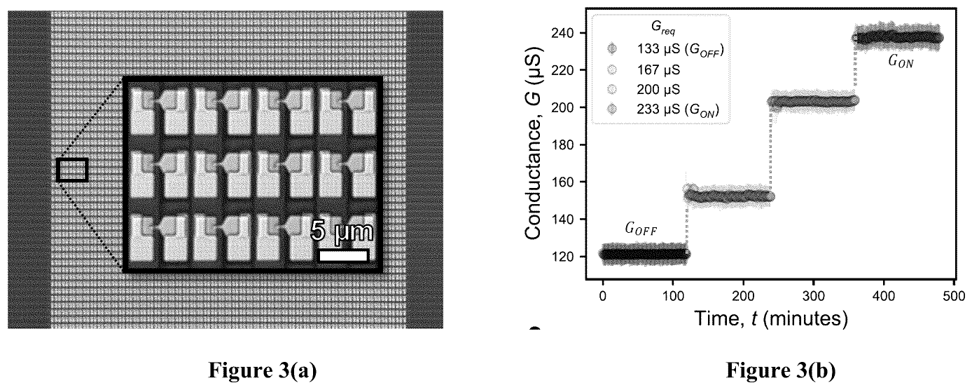

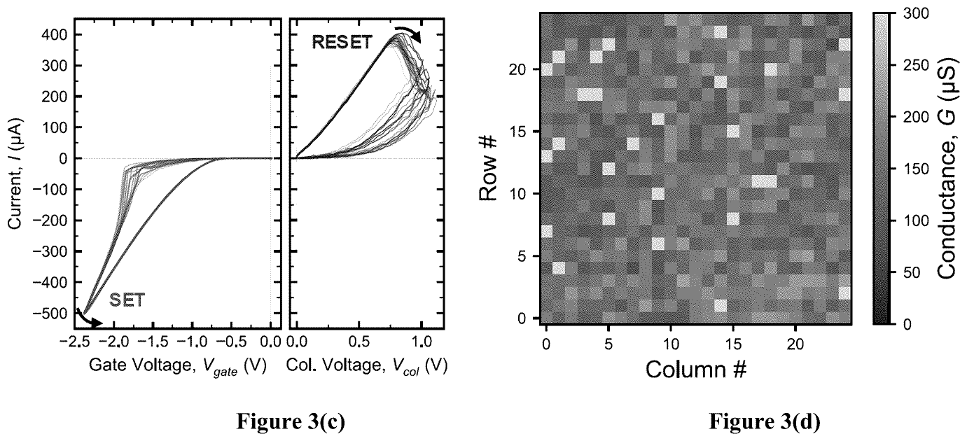

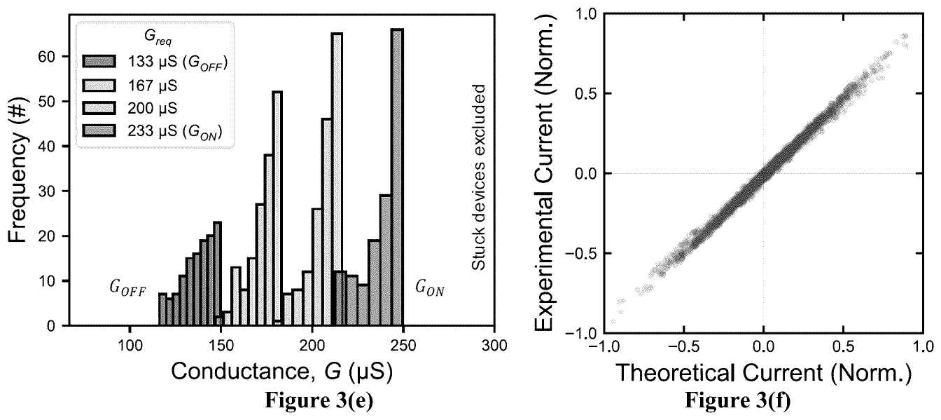

FIG. 3 illustrates properties of one example embodiment of memristor devices and arrays that may be used within the system 100 configured to implement layer ensemble averaging 180. FIG. 3(a) shows a representative subarray 151 within a larger memristor chip (e.g., a 20,000-device ReRAM array 150), demonstrating device-level integration density suitable for neural network layers. In this embodiment, individual devices are programmable to multiple conductance states, enabling quantized weight representations. FIG. 3(b) illustrates retention characteristics of a representative device programmed to a plurality of conductance states, indicating that programmed weights can remain sufficiently stable over time for inference operations. In some embodiments, two extreme conductance states (denoted G_{OFF} and G_{ON}) may be selected to represent ternary or signed neural network weights.

FIG. 3(c) shows representative current-voltage characteristics of a device across multiple programming cycles, illustrating acceptable cycle-to-cycle variability for repeated weight programming. FIG. 3(d) shows an example conductance map of a crossbar kernel after programming, and FIG. 3(e) shows the corresponding distribution of device conductances, highlighting the presence of device-to-device variability and occasional stuck-at faults. Such non-idealities may naturally produce variations across kernels or layers that can be leveraged by ensemble-based algorithms, including layer ensemble averaging 180.

FIG. 3(f) illustrates that the programmed memristor array 152 can perform vector-matrix multiplication by accumulating currents 175 in response to applied input voltages 170, with measured outputs closely tracking expected values derived from programmed conductances. In one embodiment, multiple such kernels or layers, each subject to distinct device-level variations, may be evaluated and combined at a higher algorithmic level to improve robustness and accuracy through ensemble averaging, despite individual device defects, limited precision, or programming variability.

FIG. 4 illustrates example performance characteristics of a neural network system implementing fault-tolerant inference using layer ensemble averaging (LEA) on a handwritten digit classification task, such as MNIST. See Yousuf, et al., Layer ensemble averaging for fault tolerance in memristive neural networks, Nature Communications, 16:1250 (2025). In comparative embodiments illustrated in FIG. 4, alternative fault-tolerance schemes such as mapping with inner-fault tolerance (MAO) and committee machines (CM) may be employed. In the MAO embodiment, redundancy is applied at the weight-matrix level by averaging conductance matrices prior to inference, without correcting intermediate layer outputs. See Xia, et al., Stuck-at Fault Tolerance in RRAM Computing Systems, IEEE Journal on Emerging and Selected Topics in Circuits and Systems, Vol. 8, No. 1, pp. 102-115, March 2018; and Joksas, et al. Committee machines—a universal method to deal with non-idealities in memristor-based neural networks, Nature Communications, 11:4273 (2020). In the CM embodiment, multiple independently mapped network instances generate separate inference outputs that are combined only at the final classification layer. While such comparative embodiments may provide some degree of robustness to device non-idealities, they do not correct errors as they propagate through intermediate layers. As a result, accumulated deviations arising from stuck-at faults, device variability, or limited precision may persist through the network, leading to reduced fault tolerance relative to embodiments employing LEA.

In the FIG. 4 example, device-level non-idealities are modeled to reflect realistic memristive arrays, including stuck-at-high and stuck-at-low faults distributed uniformly across the array. Devices exhibiting stuck-at-low and stuck-at-high behavior may have conductances of approximately 10 μS and 500 μS, respectively, while operable devices are programmable to one of two conductance states (e.g., 133 μS and 233 μS), consistent with the device characteristics illustrated in FIG. 3. Additional non-idealities such as read noise, write noise, and finite-precision input and output quantization may be present, leading to a mapping error between an ideal software weight matrix and its hardware-mapped counterpart.

FIG. 4(a) illustrates an example flow in which handwritten digit image samples are provided as inputs to the neural network, and the network produces a classification across multiple output classes, each class corresponding to a digit label (e.g., digits 0 through 9). FIG. 4(b) shows example network accuracy and corresponding average mapping error as functions of device fault percentage and redundancy level a for MAO, CM, and LEA, alongside a software baseline representing an ideal system without hardware non-idealities. At low redundancy (e.g., α=1), the schemes may exhibit similar behavior, while at higher redundancy levels (e.g., α≥3), differences emerge based on how each scheme aggregates mapped parameters or intermediate outputs.

In one embodiment, MAO performs averaging at the conductance-matrix level, CM performs averaging only at the final network output, and LEA performs averaging at each intermediate layer before propagating activations to subsequent layers. As illustrated in FIG. 4(b) and FIG. 4(c), layer-wise averaging in LEA reduces the propagation and accumulation of errors introduced by stuck-at devices and limited device precision, resulting in lower mapping error and higher inference accuracy compared to MAO and CM, particularly at higher redundancy levels and higher defect rates. Under fixed mapping strategies and equal device budgets, LEA produces intermediate layer activations that more closely approximate ideal values, thereby improving overall fault tolerance of the memristive neural network system.

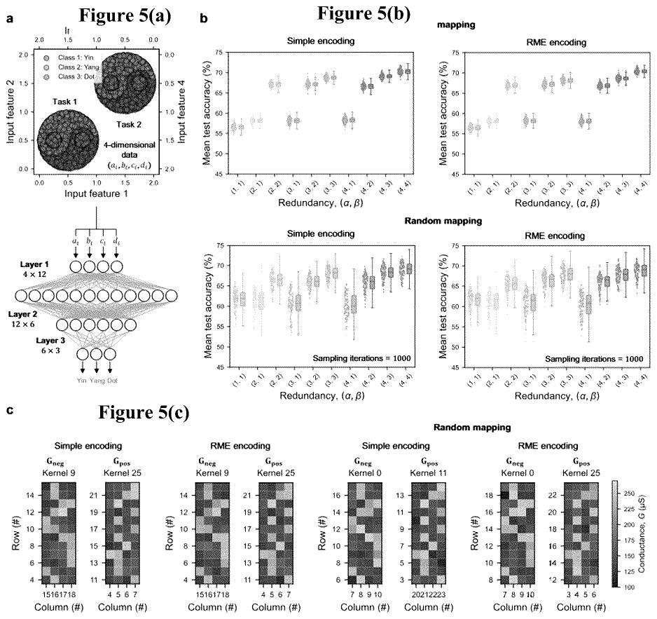

FIG. 5 illustrates an example hardware embodiment demonstrating layer ensemble averaging implemented on a memristive neural network system for a multi-task classification problem, such as the Yin-Yang dataset. FIG. 5(a) shows an example dataset and the corresponding neural network architecture configured to perform classification across multiple output tasks. In this embodiment, input samples are applied as voltage signals to the network, and the network produces classification outputs corresponding to different regions or classes within the dataset.

FIG. 5(b) illustrates example inference accuracy distributions for layer ensemble averaging under varying redundancy parameters α and β, where a denotes the number of redundant mappings of each conductance matrix and β denotes the number of redundant rows contributing to current averaging for each output. In one embodiment, different combinations of mapping algorithms (e.g., greedy or random) and encoding algorithms (e.g., simple encoding or reduced mapping error encoding) may be employed. Increasing redundancy generally improves robustness to device variability and non-idealities, and selecting β≤α enables a trade-off between inference accuracy and the number of devices actively participating in computation.

FIG. 5(c) shows example physical hardware mappings of positive and negative conductance matrices (Gₚₒₛ and G_{neg}) for a representative neural network layer. The illustrated kernel, column, and row indices correspond to physical addresses on a memristive array, such as a 20,000-device chip 150. In this embodiment, different configurations may result in distinct physical placements and encoded conductance values due to mapping strategy, encoding method, and inherent device- and system-level non-idealities, including read/write noise, device-to-device variability, and stuck-at faults.

In one embodiment, layer ensemble averaging is performed by averaging output currents at each network layer across multiple redundant rows prior to propagation to subsequent layers. This layer-wise averaging mitigates the effect of defective devices and mapping inaccuracies, enabling the hardware system to approximate the behavior of an ideal software network despite limited device precision and variability. As illustrated in FIG. 5(b), higher redundancy levels could allow the system to approach software-equivalent inference performance, while FIG. 5(c) demonstrates that such robustness could be achieved across diverse physical mappings and encoding configurations.

### Additional Features

A system for implementing a neural network on arrays of emerging memory devices using the layer ensemble averaging technique may include the device arrays themselves and a controller. The controller may be configured to perform the mapping and averaging operations. In some cases, the layer ensemble averaging technique may be implemented using a non-transitory computer-readable medium storing instructions or a custom hardware. The processor (e.g., controller) executing the instructions or the custom hardware may perform operations for mapping neural network layers to multiple copies on an array and averaging outputs from non-defective copies. The layer ensemble averaging approach provides a tradeoff between neural network accuracy and hardware resource usage when implementing neural networks on arrays of such memory devices. By leveraging redundancy and selective averaging, this technique may enable more robust and accurate implementations of artificial neural networks on faulty hardware.

In some cases, a memory device array 152 is used to implement neural network computations in hardware. As shown in FIG. 1(a), the array 152 is a two-dimensional grid of conductive wires, with memory devices 154 located at the intersection points. These memory devices 154 may act as artificial synapses, storing the weights of the neural network. Three-terminal variants or other device designs may be used instead.

The devices 154 in the array 152 may be implemented using various technologies. In some cases, resistive random-access memory (ReRAM) devices may be used as the memory elements. In other cases, alternative technologies such as phase change memory (PCM) devices or ferroelectric devices may be employed instead of ReRAM devices in the array. Other memory devices can be used instead.

The conductance states of the memory devices in the array represent the synaptic weights of the neural network. By applying voltages to the rows or columns of the crossbar and measuring the resulting currents, operations at the matrix level, such as vector-matrix multiplication, may be performed. These operations form the basis of neural network computations and are part of various machine learning algorithms, among others.

In some cases, the array 152 may enable parallel processing of neural network operations. The physical structure of the array 152 may allow for simultaneous application of input voltages and measurement of output currents, providing significant speed and energy efficiency advantages over traditional computing architectures. The simultaneous computing capabilities allow for increased energy efficiency and scalability. Since the memristor devices can be scaled to nanometer scale, the proposed solution is scalable.

The device array 152 may also face challenges such as device variability, non-ideal behavior, and potential defects. These issues may impact the accuracy and reliability of computations performed on the array. Techniques such as the layer ensemble averaging approach may be employed to mitigate these challenges and improve the overall performance of neural networks or similar computing approaches implemented on such defective arrays.

In some cases, multiple copies of a weight matrix of a neural network may be mapped on an array or across various arrays. Each copy may correspond to a layer of the neural network. This mapping process may involve algorithms for finding optimal mapping locations and handling device defects within the arrays.

The controller 110 is configured to perform the weight matrix mapping, step 202. The controller may use various algorithms to determine suitable locations on the device arrays for mapping the weight matrix copies. These algorithms may take into account factors such as device defects, variability, and available resources on the crossbar array.

In some cases, a random mapping algorithm may be used to find ensemble mappings on the defective arrays. The random mapping algorithm may generate multiple potential mapping locations randomly and evaluate their suitability based on certain criteria. This approach may provide a balance between exploration of the mapping space and computational efficiency.

Alternatively, a greedy mapping algorithm may be employed to find ensemble mappings on the defective arrays. The greedy algorithm may iteratively select the best available mapping location based on a defined metric, such as minimizing the impact of defective devices or optimizing overall network performance. This approach may provide more optimized mappings at the cost of increased computational complexity.

The mapping process may involve strategies for handling device defects within the arrays. These strategies may include identifying and avoiding faulty devices, or incorporating redundancy to mitigate the impact of defects on the performance of the neural network.

In some cases, the controller may map the weight matrix to a number of copies greater than the number of layers in the neural network. This redundancy may allow for selective averaging of outputs from multiple copies, potentially improving the overall fault tolerance and accuracy of the neural network implementation.

The weight matrix mapping process may also consider the specific characteristics of the devices in the array. Factors such as device conductance ranges, variability, and potential for state drift may influence the mapping decisions to optimize the neural network's performance on the hardware.

In some cases, the layer ensemble averaging technique may involve averaging outputs from multiple copies of each layer's mapping on the defective array. This averaging process may help mitigate the impact of device variability and defects on the performance of the neural network.

The averaging mechanism may involve averaging currents from multiple non-defective row copies to produce each layer's output. In some cases, a controller may be configured to perform this averaging operation. The controller may average outputs from multiple non-defective copies of each layer's mapping on the crossbar array to produce an output for each layer.

Redundancy parameters such as (α, β) may be used to control how many non-defective copies of each layer's rows are used for averaging. The controller may be configured to use these parameters to determine the number of copies to include in the averaging process. In some cases, increasing the values of α and β may improve the accuracy of the neural network implementation. However, increasing their values may also require using more devices in the array, as more copies of each layer's mapping are needed.

The trade-off between accuracy and resource usage controlled by the α and β parameters may allow for flexible optimization of the neural network implementation. In some cases, a and/or β may be dynamically adjusted during inference to optimize performance versus resource usage. This dynamic adjustment may allow the system to adapt to changing conditions or requirements during operation.

The averaging mechanism may operate as follows: for each layer of the neural network, the controller may identify multiple copies of that layer's mapping on the array. The number of copies used may be determined by the current value of a. B indicates how many rows (out of a) contribute to the current averaging process for each output. The controller may then measure the output currents from these copies. These currents may be averaged to produce the final output for that layer.

By averaging outputs from multiple copies, the system may reduce the impact of individual device variations or defects. If one copy of a layer's mapping contains a defective device, its impact on the final output may be minimized by averaging with outputs from other non-defective copies.

In some cases, the controller may implement more sophisticated averaging schemes. For example, the controller may apply weighted averaging, where some copies are given more importance than others based on their known reliability or performance characteristics. Alternatively, the controller may use median filtering or other statistical techniques to further improve robustness against outliers or defects.

The output averaging mechanism may be applied at different granularities within the neural network implementation or similar computing methods. In some cases, averaging may be performed at the level of individual neurons or synapses. In other cases, averaging may be applied to entire layers or sub-networks within the larger neural network structure.

The effectiveness of the output averaging mechanism may depend on various factors, including the specific characteristics of the memory devices, the architecture of the neural network, and the nature of the computation being performed. The controller may be configured to adapt the averaging strategy based on these factors to optimize overall system performance.

In some cases, network weights may be converted to conductance matrices that are mapped to memory devices in the array, for example in a differential fashion where each weight is mapped to a pair of devices. This conversion process may allow for more efficient and accurate implementation of neural networks on the hardware.

The controller may be configured to convert network weights to conductance matrices. These conductance matrices may then be mapped to devices in the crossbar array. By using differential mapping to device pairs, the system may achieve improved precision and noise immunity compared to single-device mapping approaches.

In some cases, a simple encoding scheme may be used to convert weights to conductance matrices. This simple encoding scheme may involve directly mapping positive weights to one device in a pair and negative weights to the other device. For example, a weight of +1 may be represented by setting one device to a high conductance state and the other to a low conductance state, while a weight of −1 may use the opposite configuration.

Alternatively, a reduced mapping error encoding scheme may be employed to convert weights to conductance matrices. This scheme may involve an iterative process to minimize the difference between the ideal weight values and the effective weights represented by the device conductances. The reduced mapping error approach may provide more accurate weight representation, potentially improving the overall performance of the neural network implementation.

The differential mapping of weights to device pairs may offer several advantages. This approach may allow for representation of both positive and negative weights using devices that can only have positive conductance values. Additionally, the differential scheme may provide improved tolerance to common-mode noise and drift in device characteristics.

In some cases, the controller may implement more sophisticated weight-to-conductance mapping schemes. These schemes may take into account factors such as device non-linearity, variability, and potential for state drift to optimize the accuracy and stability of the weight representation over time.

The conversion of network weights to conductance matrices and their mapping to memory device pairs may be a key step in implementing neural networks on such arrays. This process may allow for efficient hardware implementation of neural network computations while addressing challenges related to device characteristics and variability.

In some cases, an algorithm may be used for finding ensemble mappings on a defective array that avoids faulty memory devices. This algorithm may contribute to the overall fault tolerance of the system by selecting optimal mapping locations for neural network layers.

The algorithm may operate by determining summed conductance variation for potential mapping locations on the crossbar array. This summed conductance variation may serve as a metric for evaluating the suitability of different mapping locations.

In some cases, the summed conductance variation (SCV) for a potential mapping location may be calculated as follows:

$$SCV = {\sum }_{i = 1}^{n} \vert {G}_{i} - {G}_{ideal} \vert$$

Where SCV is the summed conductance variation, n is the number of devices in the potential mapping location, Gᵢ is the actual conductance of device i, and G_{ideal} is the ideal conductance for that device based on the desired weight value. The stuck-at faults have a higher contribution to the SCV metric compared to other non-idealities such as device-to-device variability and read/write noise. The present mapping approach is able to consistently find locations for redundant mappings that do not contain devices with stuck-at faults for the small network layers, which is made possible because our mapping approach can rely on the SCV metric.

The algorithm may evaluate multiple potential mapping locations on the array, calculating the summed conductance variation for each location. By comparing these values, the algorithm may identify mapping locations with the least summed conductance variation.

In some cases, the algorithm may use a greedy approach, iteratively selecting the best available mapping location based on the summed conductance variation metric. Alternatively, the algorithm may employ a random sampling approach, evaluating a set number of randomly selected potential mapping locations and choosing the best among them.

The algorithm may also incorporate strategies for avoiding known faulty devices on the array. In some cases, this may involve maintaining a map of known defective devices and excluding potential mapping locations that include these devices from consideration.

By selecting mapping locations with the least summed conductance variation, the algorithm may help minimize the impact of device non-idealities and variability on the neural network implementation. This approach may contribute to improved accuracy and reliability of the neural network computations performed on defective memory arrays.

In some cases, the algorithm may be executed by a controller configured to manage the mapping of neural network layers to the memory array. The controller may use the results of the algorithm to determine the final mapping locations for each layer of the neural network.

The fault avoidance algorithm may work in conjunction with the layer ensemble averaging technique. By finding optimal mapping locations for multiple copies of each neural network layer, the algorithm may enhance the effectiveness of the averaging process in mitigating the impact of device variability and defects.

In some cases, the algorithm may be adaptive, updating its mapping decisions based on observed performance or changes in device characteristics over time. This adaptivity may allow the system to maintain optimal performance even as the properties of the devices evolve with use.

The fault avoidance algorithm may be an important component in realizing robust and accurate implementations of neural networks on emerging hardware fabrics. By intelligently selecting mapping locations and avoiding faulty devices, the algorithm may help overcome some of the challenges associated with using non-ideal hardware for neural network computations.

In some cases, the layer ensemble averaging technique may be applied to neural networks with non-ternary weight quantization schemes. The system may adapt the mapping and averaging processes to accommodate a wider range of weight values, potentially allowing for more complex and expressive neural network architectures. This adaptation may involve modifying the weight-to-conductance conversion process and adjusting the averaging algorithm to handle the expanded range of weight representations.

The layer ensemble averaging approach may be implemented for natural language processing tasks on edge devices. In some cases, the system may map compact language models to non-volatile memory arrays, utilizing the fault tolerance provided by layer ensemble averaging to maintain accuracy despite hardware constraints. This implementation may enable more sophisticated natural language processing capabilities on resource-limited edge devices, potentially improving tasks such as speech recognition, machine translation, or text summarization.

Real-time optimization may benefit from the implementation of layer ensemble averaging on memristive hardware. The system may map neural networks designed for system optimization to arrays, leveraging the technique's ability to maintain accuracy in the presence of hardware non-idealities. This approach may enable more efficient real-time decision-making for fault detection, and system management within smart grid systems, wireless communication systems and industrial process control.

In some cases, layer ensemble averaging may be applied in online or incremental learning scenarios. The system may dynamically update the neural network weights on the memory array while maintaining fault tolerance through the ensemble approach. This implementation may allow for adaptive learning in real-time applications, potentially enabling systems that can continuously improve their performance based on new data without compromising reliability.

Physics modeling applications may utilize layer ensemble averaging implemented on memristive hardware to reliably solve systems of differential equations. The system may map complex physical models to arrays, using the technique to mitigate the impact of hardware variability on long-term simulations. This approach may enable more detailed or extended predictions by allowing larger models to be run efficiently on memristive hardware. Such predictions could be applicable to weather predictions, robotics control etc.

In some cases, the layer ensemble averaging technique may be applied to convolutional neural network layers. The system may adapt the mapping and averaging processes to accommodate the specific structure of convolutional layers, potentially allowing for efficient implementation of image processing and computer vision tasks on memristive hardware. This adaptation may involve modifying the weight mapping strategy to preserve the spatial relationships inherent in convolutional operations.

Medical image analysis applications may benefit from the implementation of layer ensemble averaging on energy-efficient memory hardware. The system may map neural networks designed for tasks such as anomaly detection, segmentation, or classification in medical imaging to memory arrays. The fault tolerance provided by the technique may help maintain high accuracy in critical diagnostic tasks, potentially improving the reliability of automated medical image analysis.

Signal processing applications may leverage layer ensemble averaging implemented on such memory hardware. The system may map neural networks designed for tasks such as filtering, compression, or feature extraction to arrays. The fault tolerance provided by the technique may help maintain accurate signal processing capabilities despite potential hardware variations, potentially enabling more efficient and reliable signal processing systems. Such techniques could also be used for human-computer systems, to map neural networks designed for tasks such as gesture recognition, emotion detection, or user intent prediction to hardware arrays.

In one embodiment, it is noted that Memristor-based hardware accelerators for deep learning are a viable option to circumvent high energy demands of modern-day machine learning workloads. However, device nonidealities impact the performance of these accelerators, preventing them from attaining software-equivalent performance. The present system is a fault-tolerant scheme for memristor-based computing systems that can enhance the performance of memristor-based hardware accelerators and bring them on par with their software counterpart. The present system can be used to realize accurate dot product and vector-matrix multiplication operations even in defective memristor-based hardware accelerators. It is useful for domains that require accurate multiply-and-accumulate or vector-matrix multiplication operations such as deep learning, digital signal processing, image and video processing, scientific computing, and financial modeling. The present system of layer ensemble averaging in a memristor prototype out-performs both the Mapping Algorithm with Inner-Fault tolerance (MAO) and Committee Machines (CM)—two existing state-of-the-art hardware-based fault tolerance methods. Existing fault-tolerant schemes in literature have been explored in simulated settings with idealistic conditions that do not exist in practical implementations. The present system is able to successfully tolerate defects and attain software-equivalent performance directly on hardware.

A number of implementations have been described. Nevertheless, it will be understood that various modifications may be made without departing from the spirit and scope of the disclosure. Accordingly, other implementations are within the scope of the following claims. The papers and references cited above are herein incorporated by reference in their entireties.

1. A method for implementing a neural network, on a memory device array having a plurality of memory devices, one or more of the memory devices having a defect, the method comprising:
mapping, by a controller, a weight matrix of the neural network to multiple copies on the memory device array, wherein each copy corresponds to a layer of the neural network; and
averaging, by the controller, outputs from multiple non-defective copies of each layer's mapping on the memory device array to produce an output for each layer.

2. The method of claim 1, further comprising using redundancy parameters such as (α, β) that controls how many non-defective copies of each layer's rows are used for averaging, and improves accuracy at the cost of using more devices.

3. The method of claim 1, further comprising converting neural network weights to conductance matrices that are mapped to memory devices.

4. The method of claim 1, further comprising using an algorithm for finding ensemble mappings on a defective array that avoids faulty devices.

5. The method of claim 4, wherein the algorithm comprises:
quantitatively measuring variation for potential mapping locations on the arrays; and
selecting mapping locations based on the quantitative measuring.

6. The method of claim 1, wherein averaging outputs comprises averaging currents from multiple non-defective row copies to produce each layer's output.

7. A system for implementing a neural network on a memory device array having memory devices with defects, the system comprising:
a memory device array having a plurality of memory devices; and
a controller configured to:
map a weight matrix of the neural network to multiple memory device subsets on the memory device array, and
average outputs from the multiple memory device subsets to produce an inference output for the memory device array to produce an output for each memory device subset.

8. The system of claim 7, wherein the controller is further configured to use redundancy parameters such as (α,β) that control how many non-defective copies of each layer's rows are used for averaging and improves accuracy at the cost of using more devices.

9. The system of claim 7, wherein the controller is further configured to convert network weights to conductance matrices that are mapped memory devices in the array.

10. The system of claim 7, wherein the controller is further configured for measuring the array of devices and identifying the working devices and the faulty devices.

11. The system of claim 7, wherein the controller is further configured to use an algorithm for finding ensemble mappings on the array that avoids faulty devices.

12. The system of claim 11, wherein the algorithm is configured to:
determine a quantitative measure for potential mapping locations on the crossbar array; and
select mapping locations based on the determined quantitative measure.

13. The system of claim 7, wherein averaging outputs comprises averaging currents from multiple non-defective row copies to produce each layer's output.

14. The system of claim 7, wherein said system improves the neural network performance on hardware despite some memory devices having variations or defects.

15. A non-transitory computer-readable medium storing instructions that, when executed by a processor, or a custom hardware that can perform operations for implementing a neural network on a defective memory array, the operations comprising:
mapping a weight matrix of the neural network to multiple copies on the array, wherein each copy corresponds to a layer of the neural network; and
averaging outputs from multiple non-defective copies of each layer's mapping on the crossbar array to produce an output for each layer.

16. The non-transitory computer-readable medium or custom hardware of claim 15, wherein the operations further comprise using redundancy parameters (α,β) that control how many non-defective copies of each layer's rows are used for averaging, and improves accuracy at the cost of using more devices.

17. The non-transitory computer-readable medium or custom hardware of claim 15, wherein the operations further comprise converting network weights to conductance matrices that are mapped to memory devices in the crossbar array.

18. The non-transitory computer-readable medium or custom hardware of claim 15, wherein the operations further comprise using an algorithm for finding ensemble mappings on the defective memory array that avoids faulty devices.

19. The non-transitory computer-readable medium or custom hardware of claim 15, wherein the processor is further configured to:
quantitatively measure variation for potential mapping locations on the arrays; and
select mapping locations based on the quantitative measuring.
